(19) United States
(12) Patent Application Publication
(10) Pub. No.: US 2026/0095069 A1
(43) Pub. Date: Apr. 2, 2026

(54) MAGNETIC ALIGNMENT COMPONENTS FOR INDUCTIVE CHARGING SYSTEMS

(71) Applicant: Apple Inc., Cupertino, CA (US)

(72) Inventors: Benjamin Morse, San Jose, CA (US); Grant S. Haug, Mountain View, CA (US)

(73) Assignee: Apple Inc., Cupertino, CA (US)

(21) Appl. No.: 19/035,715

(22) Filed: Jan. 23, 2025

Related U.S. Application Data
(60) Provisional application No. 63/700,057, filed on Sep. 27, 2024.

(51) Int. Cl. H02J 50/90; H01F 27/28; H02J 50/10

(52) U.S. Cl. CPC H02J 50/90; H01F 27/28; H02J 50/10

(57) ABSTRACT

Annular and/or rotational magnetic alignment components of magnetic alignment systems for wireless charging of devices can be enhanced with additional magnetic regions to provide increased attachment strength while preserving compatibility with other (baseline) magnetic alignment components that do not include the additional magnetic regions.

### CROSS-REFERENCE TO RELATED APPLICATION

This application claims the benefit of U.S. Provisional Application No. 63/700,057, filed Sep. 27, 2024, the disclosure of which is incorporated by reference herein.

### BACKGROUND

This disclosure relates generally to magnetic alignment components for wireless charging systems and more specifically to magnetic alignment components with improved characteristics.

Portable electronic devices (e.g., mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, requires the portable electronic device to be physically tethered to a power outlet. Additionally, using a charging cord requires the mobile device to have a connector, typically a receptacle connector, configured to mate with a connector, typically a plug connector, of the charging cord. The receptacle connector includes a cavity in the portable electronic device that provides an avenue via which dust and moisture can intrude and damage the device. Further, a user of the portable electronic device has to physically connect the charging cable to the receptacle connector in order to charge the battery.

To avoid such shortcomings, wireless charging technologies (also referred to as inductive charging technologies) have been developed that exploit electromagnetic induction to charge portable electronic devices without the need for a charging cord. For example, some portable electronic devices can be recharged by merely resting the device on a charging surface of a wireless charger device. A transmitter coil disposed below the charging surface is driven with an alternating current that produces a time-varying magnetic flux that induces a current in a corresponding receiver coil in the portable electronic device. The induced current can be used by the portable electronic device to charge its internal battery.

For devices with planar inductive charging coils, it is often desirable to align the coils (e.g., coaxially) during charging, to maximize efficiency of wireless power transfer. To facilitate alignment of the coils, some wireless charging systems incorporate magnetic alignment components. For instance, complementary magnets or magnetic structures can be placed in corresponding areas adjacent to the transmitter and receiver coils. When the devices are brought into proximity with each other, magnetic attraction between the magnets can help to align the coils and/or to hold the devices in the desired alignment.

### SUMMARY

Certain magnetic alignment systems provide annular magnetic alignment components (also referred to as “magnet rings”) that are arranged coaxially with the inductive coils. A “primary” annular magnetic alignment component in the transmitter device and a “secondary” annular magnetic alignment component have different magnetic polarizations that attract each other. For instance, a primary magnet ring can have a “quad-pole” magnetization with inner and outer annular regions having opposite axial polarizations and a non-magnetized region separating the inner and outer annular regions, while a secondary magnet ring can have a radial magnetic polarization that gives rise to a DC magnetic flux loop when aligned with the quad-pole of the primary magnet ring. The annular magnetic alignment components may have rotational symmetry such that the devices being aligned are aligned in the axial direction but not at any particular rotational angle. To provide rotational alignment, some magnetic alignment systems that include annular magnetic alignment components also include a rotational magnetic alignment component, such as a rectangular magnet disposed outboard of and spaced apart from the annular magnetic alignment components. The rotational magnetic alignment components in the transmitter and receiver devices can be have complementary polarization such that they attract each other into a desired rotational alignment. In the context of a wireless charging ecosystem of interoperable devices, the inner and outer diameters of the primary and secondary annular magnetic alignment components and the dimensions and positions of rotational magnetic alignment components may be specified to ensure interoperability.

According to various embodiments of the present invention, annular and/or rotational magnetic alignment components can be enhanced with additional magnetic regions to provide increased attachment strength while preserving compatibility with other (baseline) magnetic alignment components that do not include the additional magnetic regions.

For example, an enhanced primary annular magnetic alignment component can include an inner magnetized annular region having a magnetic polarity oriented in a first axial direction; a middle magnetized annular region having a magnetic polarity oriented in a second axial direction opposite the first direction; an outer magnetized annular region having a magnetic polarity oriented in the first axial direction; a first non-magnetized annular region disposed between the inner annular region and the middle annular region; and a second non-magnetized annular region disposed between the inner annular region and the middle annular region. The dimensions and magnetization of the inner magnetized annular region, the middle magnetized annular region, and the first non-magnetized annular region can be matched to a magnetic configuration of a baseline primary annular magnetic alignment component. Enhanced performance can be provided by the second non-magnetized annular region and the outer magnetized annular region, which are not present in the baseline primary annular magnetic alignment component.

A corresponding enhanced secondary annular magnetic alignment component can include an inner annular region with a magnetic orientation in a first radial direction and an outer annular region with a magnetic orientation in second radial direction opposite the first radial direction. The inner annular region and the outer annular region can be separated by a gap or non-magnetized region (which can be narrow). The dimensions and magnetization of the inner annular region can be matched to a magnetic configuration of a baseline secondary annular magnetic alignment component that attaches to the baseline primary annular magnetic alignment component. Enhanced performance can be provided by the outer annular region, which is not present in the baseline secondary annular magnetic alignment component.

In this example, when an enhanced primary annular magnetic alignment component and an enhanced secondary annular magnetic alignment component are brought into proximity, the added magnetic flux in the outer annular regions can increase the strength of the attachment and/or lateral alignment forces. When an enhanced primary magnetic alignment component is brought into proximity with a baseline secondary magnetic alignment component (or vice versa), the outer annular region of the enhanced component may have negligible effect or a beneficial effect on the strength of the attachment and/or alignment forces. In this manner, enhanced annular magnetic alignment components can be compatible with baseline annular magnetic alignment components in existing devices while enabling enhanced performance in newer devices.

Some embodiments provide enhanced rotational magnetic alignment components, which can be rectangular magnetic structures placed outboard of and spaced apart from the annular magnetic alignment components. For example, a baseline configuration for a rectangular rotational magnetic alignment component can include a first magnetic region having magnetic polarization in a first axial direction, a second magnetic region disposed to one side of the central magnetic region and having magnetic polarization in a second axial direction opposite the first axial direction, and a third magnetic region disposed to the side opposite the first side of the central magnetic region and having magnetic polarization in the second axial direction. The central magnetic region can be separated from the second and third magnetic regions by non-magnetized regions. Such baseline rotational magnetic alignment components can be magnetically attracted to other baseline rotational magnetic alignment components having a complementary pattern of magnetic polarization. An enhanced rotational magnetic alignment component can have the same lateral dimensions as the baseline rotational magnetic alignment component but instead of axial polarization, the enhanced rotational magnetic alignment component can have a non-magnetic central region. A first magnetized region with magnetic polarization in a first lateral direction can be disposed at one side of the non-magnetic central region, and a second magnetized region with magnetic polarization in a second lateral direction opposite the first direction can be disposed at the opposite side of the non-magnetic central region. For instance, each of the first and second magnetized regions can have its magnetic north pole oriented toward the non-magnetic central region. Assuming the dimensions of the enhanced rotational magnetic alignment component are matched to the baseline rotational magnetic alignment component, magnetic attraction can produce a torque that urges the enhanced rotational magnetic alignment component into alignment with the baseline rotational magnetic alignment component. In some embodiments, an enhanced rotational magnetic alignment component can be further enhanced with additional magnetized regions having lateral polarizations to increase the torque.

The following detailed description, together with the accompanying drawings, will provide a better understanding of the nature and advantages of the claimed invention.

### BRIEF DESCRIPTION OF THE DRAWINGS

FIGS. 1A-1C illustrate a system of complementary annular magnetic alignment components having a baseline configuration.

FIGS. 2A-2C illustrate a system of complementary annular magnetic alignment components having an enhanced configuration according to some embodiments.

FIGS. 3 and 4 illustrate interoperability between baseline annular magnetic alignment components and enhanced annular magnetic alignment components according to some embodiments.

FIG. 5 is a graph showing modeled normal forces and shear forces as a function of a lateral displacement from the alignment position for various combinations of baseline and enhanced annular magnetic alignment components.

FIG. 6 shows an axial view of a clocked annular magnetic alignment system according to some embodiments.

FIGS. 7A-7D illustrate an example configuration of magnetizations for the clocked annular magnetic alignment system of FIG. 6.

FIGS. 8A-8D illustrate another example configuration of magnetizations for the clocked annular magnetic alignment system of FIG. 6.

FIGS. 9A and 9B show an example of rotational magnetic alignment components according to some embodiments.

FIGS. 10-12 show cross-section views of baseline and enhanced rotational magnetic alignment components according to some embodiments.

FIG. 13 shows a graph of modeled torque as a function of relative rotation angle for various enhanced rotational magnetic alignment components.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

Certain magnetic alignment systems provide annular magnetic alignment components (also referred to as “magnet rings”) that are arranged coaxially with the inductive coils. A primary annular magnetic alignment component (e.g., in the transmitter device) and a secondary annular magnetic alignment component (e.g., in the receiver device) have different magnetic polarizations that attract each other. (The terms “primary” and “secondary” are used herein to distinguish two alignment components having mutually attractive magnetic polarizations and have no other significance.) For instance, a baseline primary magnetic ring can have a “quad-pole” magnetization with inner and outer annular regions having opposite axial polarization and a non-magnetize region separating the inner and outer annular regions, while a baseline secondary magnet ring can have a radial polarization that forms a flux loop when aligned with the quad-pole of the primary magnet ring. The magnet rings may have rotational symmetry such that, while the coils are aligned in the axial direction, the devices containing the coils may be at different rotational angles about the axis. To provide rotational alignment, some magnetic alignment systems also include a rotational magnetic alignment component, such as a rectangular magnet disposed outboard of and spaced apart from the magnet rings. The rotational magnetic alignment components in the transmitter and receiver devices can be have complementary polarization such that they attract each other into a desired rotational alignment.

The strength of the attachment force in such magnetic alignment systems depends on various factors, including the volume of magnetic material. In the context of a wireless charging ecosystem of interoperable devices, the lateral dimensions (e.g., inner and outer diameters) of the primary and secondary annular magnetic alignment components and the lateral dimensions and positions of rotational magnetic alignment components may be specified (e.g., by a standard applicable to the particular ecosystem) to ensure compatibility of devices. Deviating from these specifications may render the modified components incompatible with the ecosystem. Increasing the axial thickness of the magnets in the primary and/or secondary magnetic alignment components without changing any of the lateral dimensions can increase the attachment force while retaining compatibility. However, increasing the axial thickness of the magnets may have unwanted effects. For instance, the increased thickness may necessitate increasing the overall thickness of a device that incorporates a magnetic alignment component. In addition, increasing thickness of the magnets may also increase surface Gauss (magnetic fields at the surface of a device), which may increase the risk of the device demagnetizing other magnetic objects that may come into proximity with the magnetic alignment component, such as magnetic stripes on credit cards or the like.

Certain embodiments described herein provide enhanced annular magnetic alignment components in which magnetic attachment and/or alignment strength is increased relative to a baseline configuration by increasing the outer diameter and adding magnetic poles in a manner such that the enhanced components are compatible with components having the baseline configuration. Similarly, certain embodiments described herein provide enhanced rotational magnetic alignment components having a magnetic polarization pattern that is different from but compatible with components having a baseline configuration.

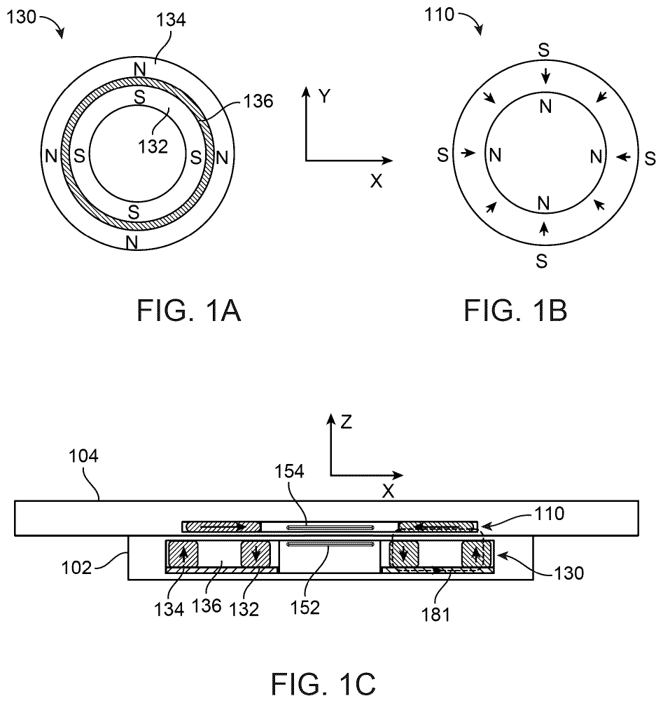

FIGS. 1A-1C illustrate a system of complementary annular magnetic alignment components having a baseline configuration. FIG. 1A shows a simplified axial view of a first (or primary) annular magnetic alignment component 130, and FIG. 1B shows a simplified axial view of a second (or secondary) annular magnetic alignment component 110. Turning first to FIG. 1A, primary annular magnetic alignment component 130 has a “quad-pole” magnetization; in other words, primary annular magnetic alignment component 130 includes an inner annular region 132 and an outer annular region 134 having magnetic polarizations in opposite axial directions, with a central annular region 136 that is non-magnetized separating inner annular region 132 and outer annular region 134. In the example shown in FIG. 1A, the magnetic south pole points axially upward (out of the page) in inner annular region 132 while the magnetic north pole points axially upward (out of the page) in outer annular region 134.

As shown in FIG. 1B, secondary annular magnetic alignment component 110 has magnetic polarization in the lateral (xy) plane, with magnetic north poles oriented radially inward. The particular construction of primary annular magnetic alignment component 130 and/or secondary annular magnetic alignment component 110 can be varied. For instance, each component can be formed using arcuate pieces of magnetic material. Gaps in the annular structure may be present, e.g., to allow electrical connection paths to pass between inboard and outboard regions of the annular component and/or to accommodate devices whose width is too small to fit the outer diameter of primary annular magnetic alignment component 130 or secondary annular magnetic alignment component 110.

Primary annular magnetic alignment component 130 and secondary annular magnetic alignment component 110 have complementary magnetizations (meaning that they mutually attract). FIG. 1C shows a simplified side cross section view of a first device 102 that incorporates primary annular magnetic alignment component 130 attached to a second device 104 that incorporates secondary annular magnetic alignment component 110. For example, first device 102 can be a wireless charger puck, and second device 104 can be a portable electronic device such as a smart phone that can be charged using first device 102. As shown, the magnetic north and south poles of secondary annular magnetic alignment component 110 are attracted to the magnetic south and north poles of primary annular magnetic alignment component 130, as indicated by flux loop 181. As shown in FIG. 1C, wireless charging coils 152, 154 can be positioned in the inboard regions of primary annular magnetic alignment component 130 and secondary annular magnetic alignment component 110 (e.g., coaxially with the annular magnetic alignment components); accordingly, annular magnetic alignment components 130, 110 can align wireless charging coils 152, 154.

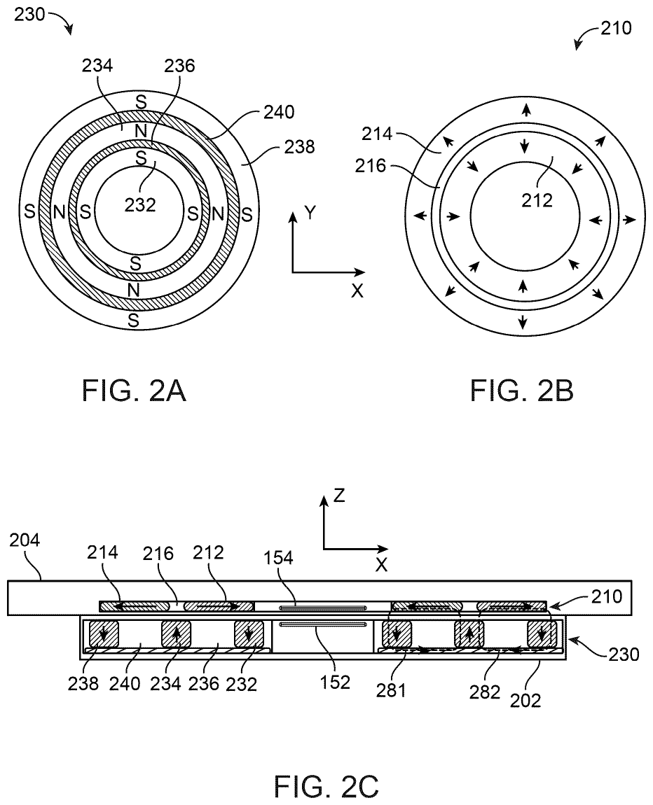

FIGS. 2A-2C illustrate a system of complementary enhanced annular magnetic alignment components according to some embodiments. FIG. 2A shows a simplified axial view of an enhanced primary annular magnetic alignment component 230, and FIG. 2B shows a simplified axial view of an enhanced secondary annular magnetic alignment component 210.

Turning first to FIG. 2A, enhanced primary annular magnetic alignment component 230 includes a first (inner) magnetized annular region 232, a second (middle) magnetized annular region 234, and a first non-magnetized annular region 236 disposed between first magnetized annular region 232 and second magnetized annular region 234. These regions can correspond to inner annular region 132, outer annular region 134, and central annular region 136 of baseline primary annular magnetic alignment component 130 and can have the same dimensions in the xy plane. In addition, enhanced primary annular magnetic alignment component 230 includes a third (outer) magnetized annular region 238 outboard of second magnetized annular region 234 and a second non-magnetized annular region 240 disposed between second magnetized annular region 234 and third magnetized annular region 238. First magnetized annular region 232 and second magnetized annular region 234 have magnetic polarizations in opposite axial directions (which provide compatibility with baseline secondary annular magnetic alignment component 110).

Third magnetized annular region 238 has magnetic polarization in the same axial direction as first magnetized annular region 232 (opposite to the axial polarization direction as second magnetized annular region 234). This magnetic configuration is sometimes referred to herein as a “hex-pole” configuration. In the example shown in FIG. 2A, the magnetic south pole points axially upward (out of the page) in first magnetized annular region 232 and third magnetized annular region 238 while the magnetic north pole points axially upward (out of the page) in second magnetized annular region 234.

As shown in FIG. 2B, enhanced secondary annular magnetic alignment component 210 has an inner annular region 212 having magnetic polarization in the lateral plane, with magnetic north poles oriented radially inward; inner annular region 212 corresponds to baseline secondary annular magnetic alignment component 110 and can have the same dimensions in the xy plane. In addition, secondary annular magnetic alignment component 210 has an outer annular region 212 having magnetic polarization in the lateral plane in a direction opposite to the polarization direction of inner annular region 212. In the example shown in FIG. 2B, the magnetic north pole points radially inward in inner annular region 212 and radially outward in outer annular region 214. Inner annular region 212 and outer annular region 214 can be separated by a narrow gap 216, which can be empty or filled with non-magnetized material.

The particular construction of enhanced primary annular magnetic alignment component 230 and/or enhanced secondary annular magnetic alignment component 210 can be varied. For instance, each component can be formed using arcuate sections of magnetic material (e.g., NdFeB, other rare earth magnetic materials, or other magnetic materials) that have been magnetized appropriately. Gaps in the annular structure of either or both of enhanced primary annular magnetic alignment component 230 and/or enhanced secondary annular magnetic alignment component 210 may be present, e.g., to allow electrical connection paths to pass between inboard and outboard regions of the annular component and/or to accommodate devices whose width is too small to fit the outer diameter of primary annular magnetic alignment component 230 or secondary annular magnetic alignment component 210.

Enhanced primary annular magnetic alignment component 230 and enhanced secondary annular magnetic alignment component 210 have complementary magnetizations (meaning that they mutually attract). FIG. 2C shows a simplified side cross section view of a first device 202 that incorporates primary annular magnetic alignment component 230 attached to a second device 204 that incorporates secondary annular magnetic alignment component 210. For example, first device 202 can be a wireless charger puck, and second device 204 can be a portable electronic device such as a smart phone that can be charged using first device 202. As indicated by flux loops 281, 283, the magnetic north and south poles of secondary annular magnetic alignment component 210 are attracted to the magnetic south and north poles of primary annular magnetic alignment component 230. As shown in FIG. 2C, wireless charging coils 152, 154 can be positioned in the inboard regions of enhanced primary annular magnetic alignment component 230 and enhanced secondary annular magnetic alignment component 210 (e.g., coaxially with the alignment components); accordingly, enhanced annular magnetic alignment components 230, 210 can align wireless charging coils 152, 154 in the same manner as baseline annular magnetic alignment components 130, 110.

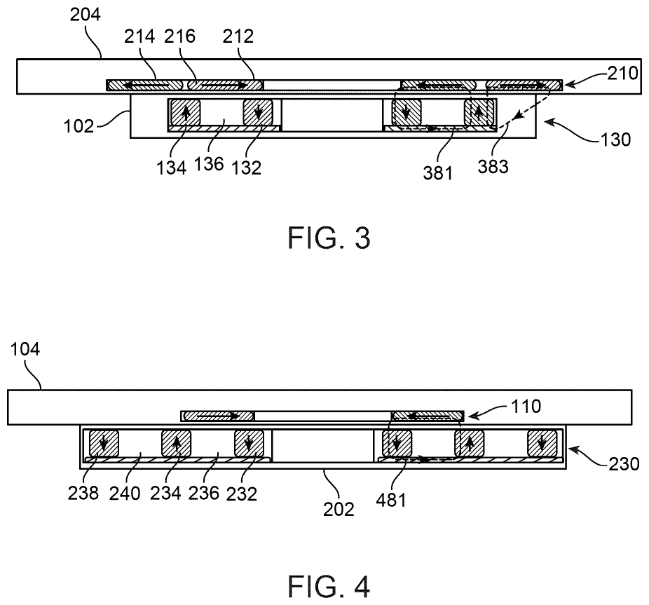

As shown in FIGS. 3 and 4, enhanced primary annular magnetic alignment component 230 and enhanced secondary annular magnetic alignment component 210 are also compatible with baseline secondary annular magnetic alignment component 110 and baseline primary annular magnetic alignment component 130.

FIG. 3 shows a simplified side cross section view of first device 102 that incorporates baseline primary annular magnetic alignment component 130 attached to second device 204 that incorporates enhanced secondary annular magnetic alignment component 210. As shown, outer annular region 212 of enhanced secondary annular magnetic alignment component 210 extends beyond the outer diameter of baseline primary annular magnetic alignment component 130.

Magnetic attachment is provided primarily by the attraction between inner annular region 212 of enhanced secondary magnet ring 210 and the quad-pole magnetic configuration of baseline primary magnet ring 230, as indicated by flux loop 381. An ancillary magnetic flux loop 383 can arise between outer annular region 212 of enhanced secondary magnet ring 210 and outer annular region 134 of baseline primary magnet ring 230, and the attachment configuration shown in FIG. 3 may provide somewhat enhanced magnetic attachment force as compared to the baseline attachment configuration of FIG. 1C.

FIG. 4 shows a simplified side cross section view of first device 202 that incorporates enhanced primary magnetic alignment component 230 attached to second device 104 that incorporates baseline secondary magnet ring 110. As shown, third magnetized annular region 238 and second non-magnetized annular region 240 extend beyond the outer diameter of baseline secondary magnet ring 110. Magnetic attachment is provided by the attraction between baseline secondary magnet ring 110 and the quad-pole formed by first magnetized annular region 232, second magnetized annular region 234, and first non-magnetized annular region 236, as indicated by flux loop 481. The resulting attachment strength is comparable to the baseline-baseline attachment shown in FIG. 1C.

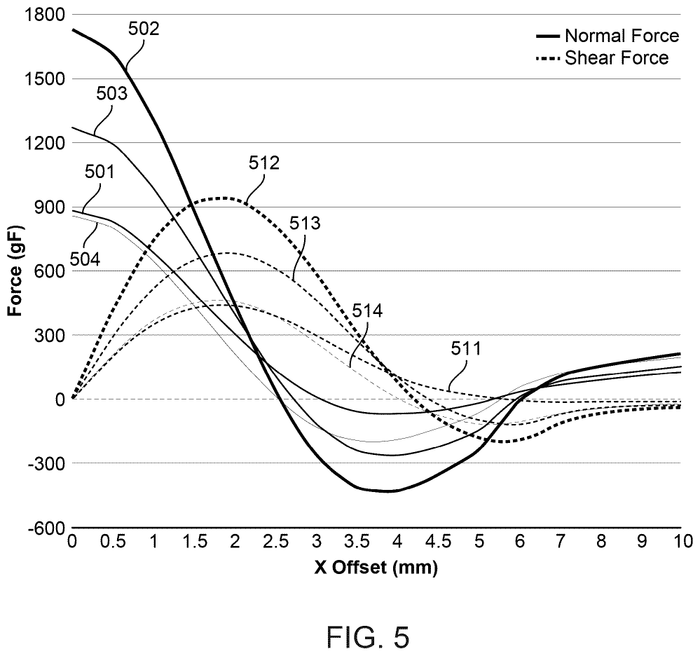

Further illustrating the compatibility of baseline and enhanced annular magnetic alignment components, FIG. 5 is a graph showing normal force (solid lines) and shear force (dashed lines) modeled as a function of lateral displacement from the alignment position in the x direction for the attachment configurations of FIGS. 1C, 2C, 3, and 4. Normal force corresponds to the attachment force in the axial (z) direction between the primary and secondary magnet rings, and shear force corresponds to a restoring force in the x-direction that urges toward axial alignment. Forces are modeled using simulation techniques with different configurations of annular magnetic alignment components. Normal force curve 501 and shear force curve 511 represent the baseline configuration of FIG. 1C. Normal force curve 502 and shear force curve 512 represent the fully enhanced configuration of FIG. 2C. Normal force curve 503 and shear force curve 513 represent the configuration of FIG. 3 (enhanced secondary magnet ring and baseline primary magnet ring). Normal force curve 504 and shear force curve 514 represent the configuration of FIG. 4 (baseline secondary magnet ring and enhanced primary magnet ring). As can be seen, the fully enhanced configuration of FIG. 2C provides forces that are significantly greater (by close to a factor of 2) than the baseline configuration of FIG. 1C. The mixed configuration of FIG. 3 provides forces that are also greater than the baseline configuration (though less than the fully enhanced configuration). The mixed configuration of FIG. 4 provides forces that are similar to the baseline configuration. Thus, baseline annular magnetic alignment components 130 and 110 are interchangeable with enhanced annular magnetic alignment components 230 and 210, which facilitates introduction of devices that include enhanced annular magnetic alignment components 230 and 210 into a pre-existing wireless charging ecosystem with devices that include baseline annular magnetic alignment components 130 and 110.

The foregoing examples are illustrative of enhanced magnet rings (or annular magnetic alignment components) having additional magnetization regions that provide increased attachment forces when used with other enhanced magnet rings and that also interconnect with baseline magnet rings having fewer magnetization regions. The design of enhanced magnet rings can be varied. For instance, while the lateral dimensions (including radial widths) of annular regions that correspond to the annular regions of the baseline magnet rings should match the baseline configuration (to maintain interoperability as shown in FIGS. 3 and 4), radial widths and magnetization patterns of the added annular regions can be chosen as desired. In one specific example, the radial width of third annular magnetized region 238 of primary annular magnetic alignment component 230 can be less than the radial width of second annular magnetized region 234 or first annular magnetized region 232. Where this is the case, outer annular region 214 of secondary annular magnetic alignment component 210 can have a narrower radial width than inner annular region 212. Alternatively, outer annular region 214 of secondary annular magnetic alignment component 210 can have the same radial width as inner annular region 212 and the radial width of second non-magnetized region 240 in primary annular magnetic alignment component 230 can be increased so that third annular magnetized region 238 in primary annular magnetic alignment component 230 aligns with the outer edge of outer annular region 214 in secondary annular magnetic alignment component 210. Other variations are also possible.

It should be noted that enhanced annular magnetic alignment components 230, 210 have an increased total volume of magnetic material as compared to baseline annular magnetic alignment components 130, 110. This increase can be achieved without increasing the axial thickness of any component. This can provide various advantages. For instance, thinner magnets can be used, particularly for secondary annular magnetic alignment component 210 (which is laterally polarized than axially polarized) while still providing sufficient attachment force. In addition, particularly for radially polarized components (e.g., secondary annular magnetic alignment component 210), thinner magnets provide lower surface Gauss than thicker magnets. Lower surface Gauss provides less risk of demagnetization of other magnetic elements (e.g., magnetic stripes on credit cards) that may come into proximity with secondary annular magnetic alignment component 210.

According to some embodiments, enhanced magnet rings (or annular magnetic alignment components) can have magnetization patterns that support clocking or toggling behavior of the attachment forces. As used herein, “clocking” (or “toggling”) refers to a configuration where the attachment force changes as attached devices are rotated relative to each other around the axis of the annular magnetic alignment components. For instance, at a first rotational angle, the attachment force may be significantly stronger than at a second rotational angle. Clocking can facilitate user interactions such as “twist to release,” where a portable device that is magnetically attached to a docking stand can be easily removed by first twisting the portable device to a rotational angle that provides reduced attachment force, then lifting the portable device away from the attachment surface of the docking station.

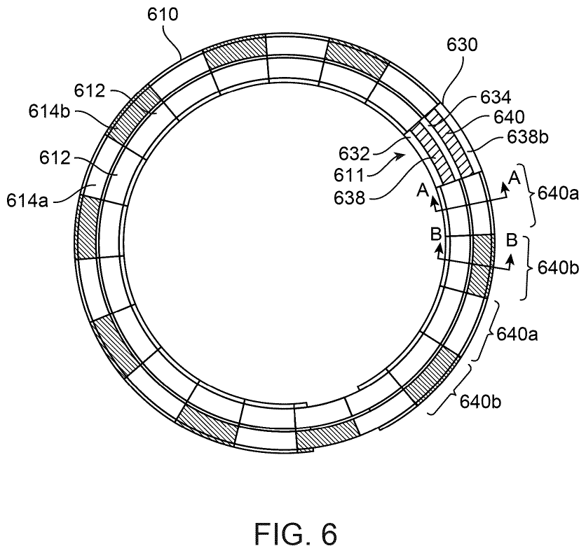

FIG. 6 shows an axial view of an enhanced secondary magnet ring 610 having a clocked magnetization aligned over an enhanced primary magnet ring 630 that also has a clocked magnetization. Enhanced secondary magnet ring 610 includes a gap 611 at approximately 2 o'clock, through which a portion of enhanced primary magnet ring 630 can be seen.

As shown in FIG. 6, each of enhanced secondary magnet ring 610 and enhanced primary magnet ring 630 is constructed with alternating magnetic sectors of a first type (sectors 640a) and a second type (sectors 640b). For instance, each sector 640a, 640b can be constructed using one or more arcuate magnets having appropriate magnetization applied, and enhanced secondary magnet ring 610 (or enhanced primary magnet ring 630) can be constructed by placing the arcuate magnets end to end. Sectors 640a and 640b can have the same dimensions (e.g., same arc length, inner radius, and outer radius) but different magnetization patterns.

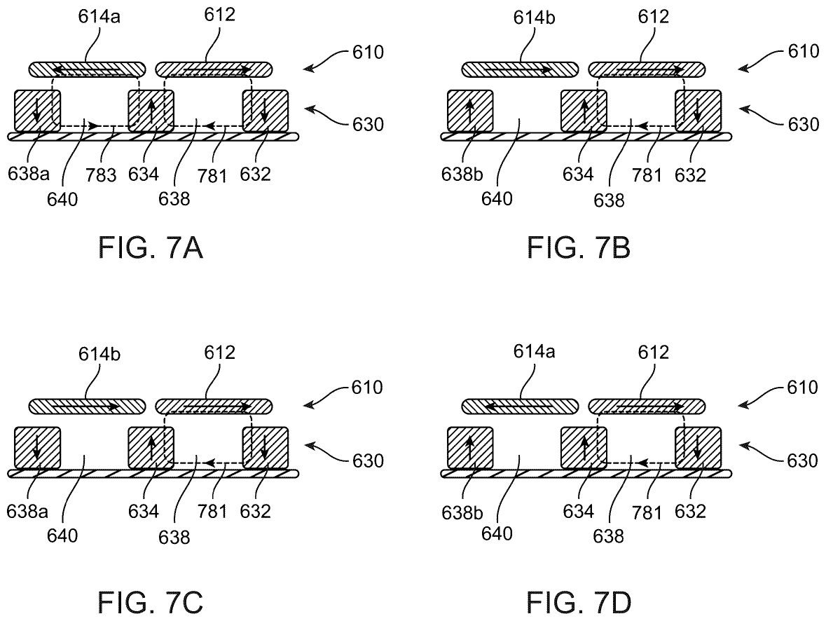

A first example of magnetization patterns for sectors 640a and 640b of magnet rings 610 and 630 is illustrated in the cross-section views of FIGS. 7A-7D. FIG. 7A shows the magnetization patterns for sectors 640a. In sectors 640a, enhanced secondary magnet ring 610 and enhanced primary magnet ring 630 can have magnetization patterns corresponding to the patterns shown in FIGS. 2A-2C. For instance, enhanced secondary magnet ring 610 can have an inner arcuate region 612 and an outer arcuate region 614a with opposite radial polarizations. Enhanced primary magnet ring 630 can have a hex-pole configuration with first and second arcuate magnetized regions 632, 634 separated by first arcuate non-magnetized region 636 and third arcuate magnetized region 638a separated from second arcuate magnetized region 634 by second arcuate non-magnetized region 638. First and second arcuate magnetized regions 632, 634 can have opposite axial polarization, and third arcuate magnetized region 638a can have axial polarization in the same direction as first arcuate magnetized region 632 (opposite the polarization direction of second arcuate magnetized region 634).

FIG. 7B shows the magnetization patterns for sectors 640b. In sectors 640b, enhanced secondary magnet ring 610 and enhanced primary magnet ring 630 can have magnetization patterns different from the patterns shown in FIGS. 2A-2C. For instance, enhanced secondary magnet ring 610 can have an inner arcuate region 612 and an outer arcuate region 614b with radial polarization in the same direction (e.g., radially inward). The polarization of inner arcuate region 612 is the same in sectors 640b as in sectors 640a; the polarization of outer arcuate region 614b is reversed. Similarly, enhanced primary magnet ring 630 can have first and second arcuate magnetized regions 632, 634 separated by first arcuate non-magnetized region 636 and third arcuate magnetized region 638a separated from second arcuate magnetized region 634 by second arcuate non-magnetized region 638. As in sectors 640a, first and second arcuate magnetized regions 632, 634 can have opposite axial polarization; however, in sectors 640b, third arcuate magnetized region 638b has axial polarization in the same direction as second arcuate magnetized region 634 (opposite the polarization direction of first arcuate magnetized region 632).

In operation, when sectors 640a of secondary magnet ring 610 are rotated into alignment with sectors 640a of primary magnet ring 630 (which implies that sectors 640b of secondary magnet ring 610 are rotated into alignment with sectors 640b of primary magnet ring 630), sectors 640a attract as indicated by flux loops 781, 783 in FIG. 7A. Sectors 640b also attract, although less strongly than sectors 640a. Flux loop 781 in FIG. 7B indicates attraction in the inner half of the arcuate sector; however, but there is no attraction between outer arcuate region 614b of secondary magnet ring 610 and second arcuate magnetized region 634 of primary magnet ring 630.

When secondary magnet ring 610 is rotated relative to primary magnet ring 630 such that sectors 640a of primary magnet ring 630 align with sectors 640b of secondary magnet ring 610 (and vice versa), the forces change. FIG. 7C illustrates a sector 640b of secondary magnet ring 610 aligned with a sector 640a of primary magnet ring 630, and FIG. 7D illustrates a sector 640a of secondary magnet ring 610 aligned with a sector 640b of primary magnet ring 630. In FIG. 7C, outer arcuate region 614b of secondary magnet ring 610 repels third arcuate magnetized region 638a and second arcuate magnetized region 634 of primary magnet ring 630, offsetting the attraction indicated by flux loop 781 and reducing the attractive force. In FIG. 7D, third arcuate magnetized region 638b of primary magnet ring 630 repels the outer portion of outer arcuate region 614a of secondary magnet ring 610. The net result is that a maximum attractive force exists when sectors 640a of primary magnet ring 630 align with sectors 640a of secondary magnet ring 610. To the extent that sectors 640a of primary magnet ring 630 align instead with sectors 640b of secondary magnet ring 610 (and vice versa), the attractive force is reduced from its maximum, thereby producing a clocking effect.

It should be noted that enhanced primary magnet ring 630 and enhanced secondary magnet ring 610 are each compatible with the baseline configuration shown in FIGS. 1A-1C, although the clocking effect may not be noticeable. Flux loop 781 would be present for both sectors and all rotational angles, but there would be little interaction between the baseline magnet ring and the outer portion of the enhanced magnet ring, so rotating one of the rings would have little effect on the force.

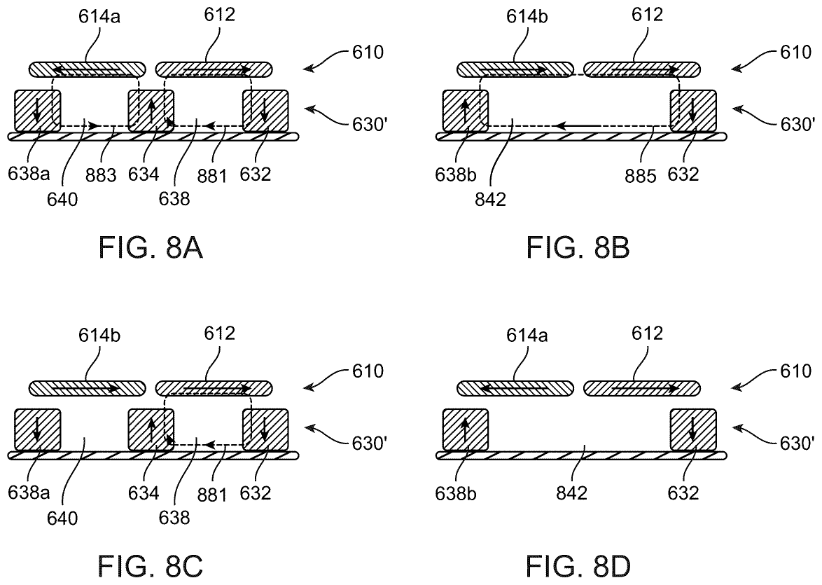

Other magnetization patterns can also be used to provide a clocking effect with larger differences between the maximum and minimum forces. FIGS. 8A-8D show cross section views illustrating another example of magnetization patterns that can be applied in a clocked magnet ring similar to the one shown in FIG. 6. In this example, secondary magnet ring 610 is identical to secondary magnet ring 610 described above and has alternating sectors 640a, 640b of two different types with the same magnetization patterns shown in FIGS. 7A and 7B. Primary magnet ring 630′ is similar to primary magnet ring 630 in having alternating sectors 640a, 640b of two different types. T The magnetization in sectors 640a is the same as shown in FIG. 7A, but the magnetization in sectors 640b is different from that shown in FIG. 7B. FIG. 8A shows the magnetization in sectors 640a. The magnetization of primary magnet ring 630′ and secondary magnet ring 610 in sectors 640a is identical to the magnetization shown in FIG. 7A (and to the configuration shown in FIG. 2C).

FIG. 8B shows the magnetization in sectors 640b. Enhanced secondary magnet ring 610 can have an inner arcuate region 612 and an outer arcuate region 614b with radial polarization in the same direction (e.g., radially inward). As in FIG. 7B, the polarization of inner arcuate region 612 is the same in sectors 640b as in sectors 640a; the polarization of the outer arcuate section is reversed. In enhanced primary magnet ring 630′, an expanded arcuate non-magnetized region 842 replaces second arcuate magnetized region 634, first arcuate non-magnetized region 636, and second arcuate non-magnetized region 640. In addition, outer arcuate magnetized region 638b has axial polarization in the opposite direction of third arcuate magnetized region 638a in FIG. 8A, so that in sectors 640b, first arcuate magnetized region 632 and outer arcuate magnetized region 638b have opposite magnetic polarization directions.

In operation, when sectors 640a of secondary magnet ring 810 are rotated into alignment with sectors 640a of primary magnet ring 630′ (which implies that sectors 640b of secondary magnet ring 610 are rotated into alignment with sectors 640b of primary magnet ring 630′), sectors 640a attract, as indicated by flux loops 881, 883 in FIG. 8A. Sectors 640b also attract, as indicated by flux loop 885 in FIG. 8B.

When secondary magnet ring 610 is rotated relative to primary magnet ring 630′ such that sectors 640a of primary magnet ring 630′ align with sectors 640b of secondary magnet ring 610 (and vice versa), the forces change. FIG. 8C illustrates a sector 640b of secondary magnet ring 610 aligned with a sector 640a of primary magnet ring 630′, and FIG. 8D illustrates a sector 640a of secondary magnet ring 610 aligned with a sector 640b of primary magnet ring 630′. In FIG. 8C, similarly to FIG. 7C, outer arcuate region 614b of secondary magnet ring 610 repels third arcuate magnetized region 638a and second arcuate magnetized region 634 of primary magnet ring 630′, offsetting the attraction indicated by flux loop 881 and reducing the attractive force. In FIG. 8D, outer arcuate magnetized region 638b of primary magnet ring 630′ repels the outer portion of arcuate region 614a of secondary magnet ring 610 and no attractive force is produced. The net result is that a maximum attractive force exists between secondary magnet ring 610 and primary magnet ring 630′ when sectors 640a of primary magnet ring 630′ align with sectors 640a of secondary magnet ring 610. To the extent that sectors 640a of primary magnet ring 630′ align instead with sectors 640b of secondary magnet ring 610 (and vice versa), the attractive force is reduced from its maximum, thereby producing a clocking effect. It should be noted that enhanced secondary magnet ring 610 is compatible with baseline primary annular alignment component 130 of FIG. 1A. Enhanced primary magnet ring 630′ is also compatible with baseline secondary annular alignment component 110 of FIG. 1B, although the attractive force may be reduced due to the absence of magnetized regions 634 in sectors 640b of enhanced primary magnet ring 630′.

The foregoing examples illustrate enhanced magnet rings (or annular magnetic alignment components) that can be used to provide clocking of attachment forces between magnet rings. The number and arc lengths of alternating sectors can be modified, and the arc lengths of sectors of different types can be the same or different.

In various embodiments described above, annular magnetic alignment components (magnet rings) can provide robust alignment in the lateral (xy) plane, e.g., to align two wireless charging coils coaxially. Clocking schemes of the kind shown in FIG. 6 (and FIGS. 7A through 8D) can provide bias toward a particular set of rotation angles; for instance, there can be a bias toward a rotational angle where sectors 640a align with sectors 640a as opposed to a rotational angle where sectors 640a align with sectors 640b. However, such clocking schemes generally do not have a bias for a single preferred rotation angle. For some applications, such as alignment of a portable electronic device with a wireless charger puck or mat, rotational orientation may not be a concern. In other applications, such as alignment of a portable electronic device in a docking station or other mounting accessory, a particular rotational alignment may be desirable. Accordingly, in some devices, an annular magnetic alignment component can be augmented with one or more rotational magnetic alignment components positioned outboard of and spaced apart from the annular magnetic alignment components. Complementary rotational magnetic alignment components in different devices can help guide and/or hold the devices in a particular rotational orientation relative to each other. According to some embodiments, a baseline system of rotational magnetic alignment components can be interoperable with an enhanced rotational magnetic alignment component. Examples will now be described.

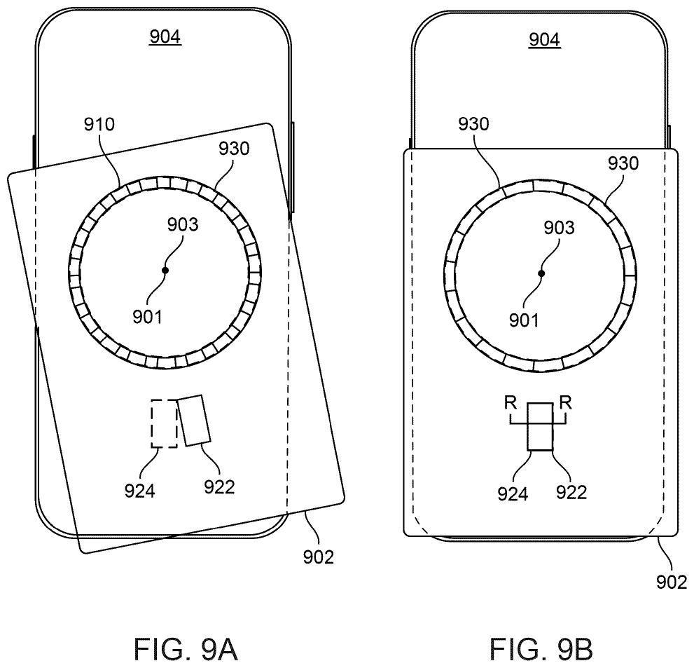

FIGS. 9A and 9B show an example of rotational alignment according to some embodiments. In FIGS. 9A and 9B, an accessory 902 includes a primary annular magnetic alignment component 930 and a rotational magnetic alignment component 922. Primary annular magnetic alignment component 930 can be, e.g., any of the baseline or enhanced primary annular magnetic alignment components (magnet rings) described above. Rotational magnetic alignment component 922 can be a rectangular magnetic element that is positioned outboard of and spaced apart from primary annular magnetic component 930. The dimensions of rotational magnetic alignment component 922 and positioning thereof (e.g., distance from center point 901 of primary annular magnetic alignment component 930) can be specified and standard for a particular wireless charging ecosystem. A portable electronic device 904 includes a secondary annular magnetic alignment component 910 and a rotational magnetic alignment component 924. Secondary annular magnetic alignment component 910 can be, e.g., any of the baseline or enhanced secondary annular magnetic alignment components (magnet rings) described above. Like rotational magnetic alignment component 922, rotational magnetic alignment component 924 can be a rectangular magnetic element that is positioned outboard of and spaced apart from secondary annular magnetic alignment component 910 by the same distance as rotational magnetic alignment component 924 is spaced apart from primary annular magnetic alignment component 930. Accessory 902 is placed on the back surface of portable electronic device 904. Primary annular magnetic alignment component 930 and secondary annular magnetic alignment component 910 are aligned with each other in the xy plane such that, in the view shown, center point 901 of primary annular alignment component 930 coincides with center point 903 of secondary annular alignment component 910. It should be understood that baseline and enhanced annular magnetic alignment components are interoperable and that “mixed” pairings of the kinds shown in FIGS. 3 and 4 may be used. In FIG. 9A, a relative rotation is present such that rotational magnetic alignment components 922 and 924 are not aligned with each other. In this configuration, an attractive torque between rotational magnetic alignment components 922 and 924 can urge portable electronic device 904 and accessory 902 toward a target rotational orientation. In FIG. 9B, the attractive torque between rotational magnetic alignment components 922 and 924 has helped to bring portable electronic device 904 and accessory 902 into the target rotational alignment with the sides of portable electronic device 904 parallel to the sides of accessory 902. In some embodiments, the attractive magnetic force between rotational magnetic alignment components 922 and 924 can also help to hold portable electronic device 904 and accessory 902 in a fixed rotational alignment.

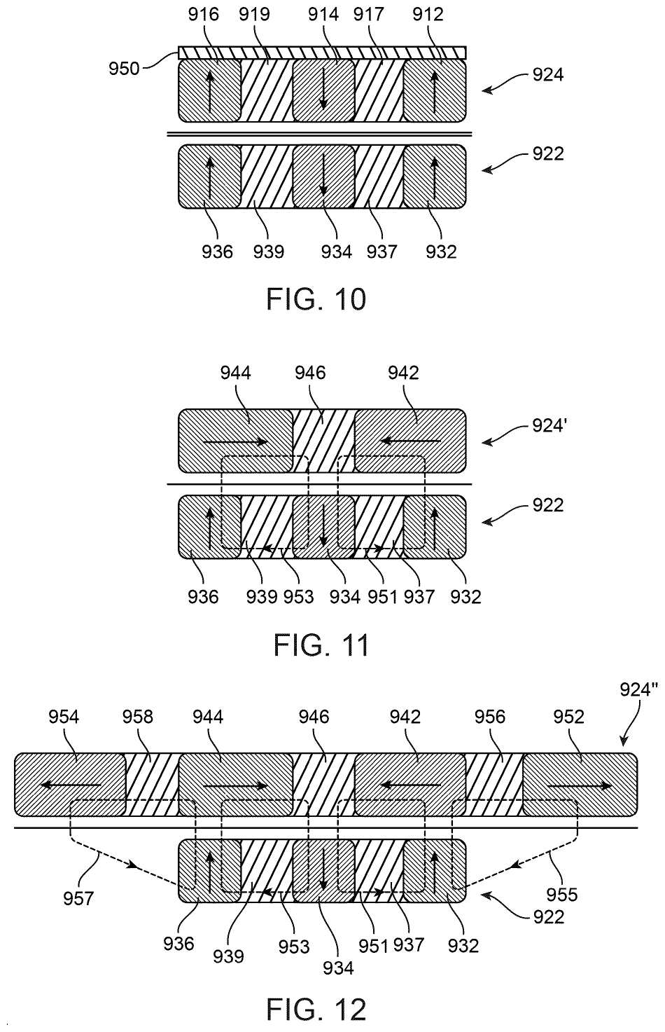

Similarly to annular magnetic alignment components described herein, attractive force between rotational magnetic alignment components 922 and 924 can be created using complementary magnetizations. In accordance with various embodiments of the invention, rotational magnetic alignment component 922 can have a baseline magnetic configuration while rotational magnetic alignment component 924 can have an enhanced magnetic configuration that can provide equal or superior torque without necessitating increases in magnet thickness. (In fact, in some instances, magnet thickness can be reduced without impairing performance.) FIGS. 10-12 show cross-section view through line R-R of FIG. 10B, illustrating different magnetization configurations that can be used for rotational magnetic alignment components 922 and 924 according to some embodiments. It should be understood that the cross section can be uniform along the length (in the y direction) of rotational magnetic alignment component 922 or 924.

FIG. 10 shows a baseline configuration. Rotational magnetic alignment component 924 has a hex-pole configuration with a first magnetized region 932 having axial magnetic polarization in a first direction, a second magnetized region 934 having axial magnetic polarization in a second direction opposite the first direction, and a third magnetized region 936 having axial magnetic polarization in the first direction. Magnetized regions 932, 934, and 936 can be separated by non-magnetized regions 937, 939. Similarly, rotational magnetic alignment component 922 has a hex-pole configuration with a first magnetized region 912 having axial magnetic polarization in a first direction, a second magnetized region 914 having axial magnetic polarization in a second direction opposite the first direction, and a third magnetized region 916 having axial magnetic polarization in the first direction. Magnetized regions 912, 914, and 916 can be separated by non-magnetized regions 917, 919. In this example, rotational magnetic alignment component 924 has a magnetic shunt 950 disposed on the distal side (the side opposite the interface to rotational magnetic alignment component 922). Magnetic shunt 950 can be made of a soft magnetic material and can act as a DC magnetic shield to redirect magnetic flux away from device components that may be located on the distal side of rotational magnetic alignment component 924. Rotational magnetic alignment components 922 and 924 have complementary polarization patterns at the attachment surface; in this example, the pole pattern of rotational magnetic alignment component 922 is N-S-N, and the pole pattern of rotational magnetic alignment component 924 is S-N-S.

FIG. 11 shows an enhanced rotational magnetic alignment component 924′ that provides attraction to baseline rotational magnetic alignment component 922 while allowing for thinner magnets. Rotational magnetic alignment component 924′ includes a first magnetized region 942 and a second magnetized region 944 separated by a central non-magnetized region 946. First magnetized region 942 and second magnetized region 944 have magnetic polarizations oriented in opposite lateral directions; for instance the magnetic north poles in both magnetized regions can be oriented toward non-magnetized region 946 while the magnetic south poles are oriented toward the edges of rotational magnetic alignment component 924′. A first magnetic flux loop 951 is created through magnetized regions 936, 944, and 934, while a second magnetic flux loop 953 is created through magnetized regions 932, 942, and 934, providing magnetic attraction toward the aligned position.

FIG. 12 shows another enhanced rotational magnetic alignment component 924″ that also provides attraction to baseline rotational magnetic alignment component 922 using thinner magnets. Like rotational magnetic alignment component 924′, rotational magnetic alignment component 924″ includes a first magnetized region 942 and a second magnetized region 944 separated by a central non-magnetized region 946. First magnetized region 942 and second magnetized region 944 have magnetic polarizations oriented in opposite lateral directions; for instance the magnetic north poles can be oriented toward non-magnetized region 946 while the magnetic south poles are oriented toward the edges of rotational magnetic alignment component 924″. In addition, rotational magnetic alignment component 924″ has a third magnetized region 952 and a fourth magnetized region 954. Third magnetized region 952 is separated from first magnetized region 942 by a non-magnetized region 956, and fourth magnetized region 954 is separated from second magnetized region 944 by a non-magnetized region 958. Third magnetized region 952 and fourth magnetized region 954 have magnetic polarizations oriented in opposite lateral directions. The lateral direction in each case is opposite to the next magnetized region. Thus, third magnetized region 952 is magnetized in a direction opposite to first magnetization region 942, and fourth magnetized region 954 is magnetized in a direction opposite to second magnetization region 944. When rotational magnetic alignment component 924″ is aligned to rotational magnetic alignment component 922, a first magnetic flux loop 951 is created through magnetized regions 936, 944, and 934, while a second magnetic flux loop 953 is created through magnetized regions 932, 942, and 934, providing magnetic attraction toward the aligned position, as in FIG. 11. In addition a third magnetic flux loop 955 is created through magnetized regions 932 and 952, and a fourth magnetic flux loop 957 is created through magnetized regions 936 and 954. Magnetic flux loops 955 and 957 can increase the attraction between rotational magnetic alignment component 924″ and rotational magnetic alignment component 920.

In the foregoing examples, one of the rotational magnetic alignment components in a pair has the baseline configuration while the other rotational magnetic alignment component can be a baseline component or an enhanced component. Orienting the magnetization in rotational magnetic alignment component 924′ (or 924″) in the lateral plane can significantly reduce surface Gauss when rotational magnetic alignment component 920 is not present, which may be particularly useful in devices that are carried in pockets or bags and may come into contact with unrelated magnetic objects such as credit cards. Thin magnets with lateral magnetization are generally less susceptible to demagnetization over time than magnets of equal thickness with axial magnetization, improving robustness of the rotational magnetic alignment component.

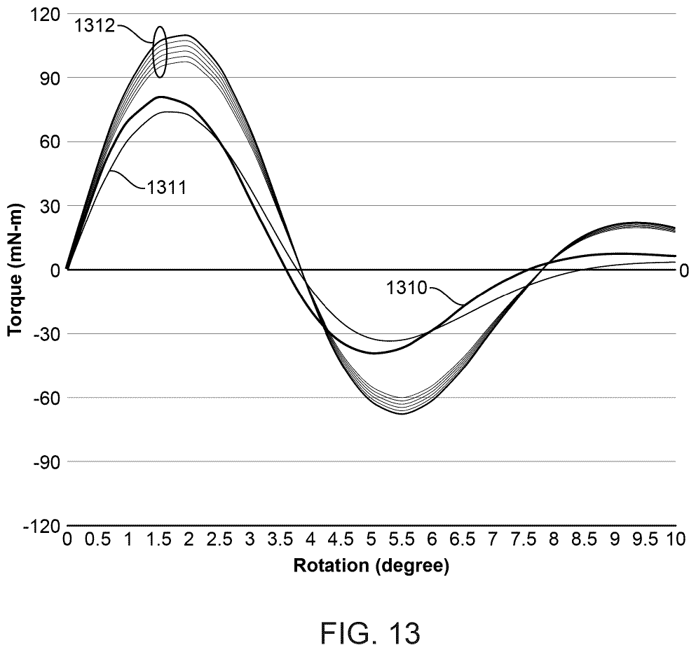

According to some embodiments, lateral magnetization can be used without adversely affecting the magnetic alignment performance. FIG. 13 shows a graph of torque modeled as a function of relative rotation angle for different implementations of an enhanced rotational magnetic alignment component. Rotation angle is defined such that the position shown in FIG. 9B corresponds to a rotation angle of zero degrees, and rotation is about the common center point 901/903 of annular magnetic alignment components 910 and 930. Torque is modeled using simulation techniques with different configurations of rotational magnetic alignment components. Line 1310 shows a torque profile for the baseline configuration shown in FIG. 10. Line 1311 shows a torque profile for the enhanced configuration shown in FIG. 11. Line group 1312 shows torque profiles for the enhanced configuration shown in FIG. 12, with different thicknesses for rotational magnetic alignment component 924″. Comparing lines 1310 and 1311 shows that rotational magnetic alignment component 924′ provides a similar torque profile to baseline rotational magnetic alignment component 924. Peak torque may be somewhat less for enhanced rotational magnetic alignment component 924′; however, the reduction in torque may be traded off against other advantages of lateral magnetization (e.g., reduced surface Gauss and reduced magnet thickness as noted above). Rotational magnetic alignment component 924″ can provide significantly increased torque as compared to baseline across a range of magnet thicknesses (thicker magnets generate more torque due to increased volume of magnetic material), in addition to providing the benefits of lateral magnetization. Design tradeoffs include the increased lateral area occupied by enhanced rotational magnetic alignment component 924″ and increased amount of magnetic material.

As these examples show, an enhanced rotational magnetic alignment component with lateral magnetization can be used in conjunction with a baseline rotational magnetic alignment component with axial magnetization as an adjunct to a system of annular magnetic alignment components. When combined in the same device, an enhanced annular magnetic alignment component with lateral magnetization (e.g., secondary annular alignment component 210) and an enhanced rotational magnetic alignment component with lateral magnetization (e.g., enhanced rotational magnetic alignment component 924′ or 924″) can provide reduced-thickness alignment components, which may allow the overall thickness of the device to be reduced or provide more internal volume for other components of the device.

While the invention has been described with reference to specific embodiments, those skilled in the art will appreciate that variations and modifications are possible. For instance, an annular magnetic alignment component (or magnet ring) can have one or more gaps, or opening, through the ring. In some instances, a gap may be provided to allow electrical connections to be made between components inboard of the magnet ring (e.g., an inductive coil) and other components outboard of the ring (e.g., power circuitry). In some instances, such as for devices having small form factors, one or more gaps may be provided to allow the device to have a dimension smaller than the outer diameter of the magnet ring; for instance, the magnet ring may have two gaps of about 30 degrees each on opposite sides of the ring. In addition to or instead of gaps extending through the ring, some enhanced magnet rings can have gaps in the outer annular region but not the inner annular region, e.g., to allow for devices with small form factors.

Magnets for magnetic alignment components of the kind described herein can be made using a permanent (or hard) magnetic material such as an NdFeB material, other rare earth magnetic materials, bonded magnets, or other materials that can be magnetized to create a persistent magnetic field. For instance, magnetic elements can be made of a magnetic material that has been ground into a sheet and cut into an arcuate shape, rectangle, or other desired shape, after which a desired magnetization (e.g., dipole, quad-pole, hex-pole) can be imparted using a magnetizer. Magnetic elements can also be fabricating using multiple dipole magnets arranged adjacent to each other. Magnet rings can be constructed by placing arcuate magnets end-to end to form an annular shape. It should also be understood that if the magnets are sufficiently small relative to the dimensions of the annular structure, trapezoidal or square magnets can approximate the behavior of arcuate magnets.

Magnetic alignment components can be used with an inductive charging coil to facilitate alignment of the coils as described above, or a magnetic alignment component can be present in a device that does not have an inductive charging coil. Further, a portable electronic device that has a magnetic alignment component around an inductive charging coil can be charged by a wireless charger device that does not have a magnetic alignment component, and conversely, a wireless charger device that has a magnetic alignment component can be used to charge a portable electronic device that has an inductive charging coil but not a magnetic alignment component. In these situations, the magnetic alignment component may not facilitate alignment between the devices, but it need not interfere with wireless power transfer. Annular magnetic alignment components can be used with or without rotational magnetic alignment components.

In addition, while certain devices may have been described as receiving (or transmitting) power wirelessly, those skilled in the art will appreciate that an inductive power coil may be operable to transmit and/or receive power wirelessly. In some embodiments some embodiments a device can be reconfigurable to operate either as a transmitter or receiver for wireless power transfer.

Further, while it is contemplated that magnetic alignment components of the kind described herein can be used to facilitate alignment between transmitter and receiver coils for wireless power transfer between devices, use of magnetic alignment components is not so limited, and magnetic alignment components can be used in a variety of contexts to hold one device in relative alignment with another, regardless of whether either or both devices have wireless charging coils. Thus, for instance, a tripod (or other type of stand), which can hold a portable electronic device in a particular position and orientation, can include a primary annular magnetic alignment component (and a rotational magnetic alignment component) to hold the portable electronic device in place; the magnetic alignment component can be used in addition to or instead of mechanical retention features to secure the portable electronic device to the tripod. As in wireless charging use-cases, baseline and enhanced magnetic alignment components can be used interchangeably.

In various embodiments, components disposed inboard of an annular magnetic alignment component can include an inductive coil such as a wireless power transmitter or receiver coil and/or other components, such as components supporting NFC for device identification and/or authentication.

It should also be understood that some devices may include multiple annular alignment components. For instance, a wireless charger device may be designed with two or more separate wireless charging coils spaced apart from each other to allow multiple portable electronic devices to be charged at the same time. Each wireless charging coil can have a surrounding primary annular alignment component, and each primary alignment component can have an associated rotational magnetic alignment component (or not).

All numerical values and ranges provided herein are illustrative and may be modified. Any measurements or quantitative relationships (e.g., equality) should be understood to be subject to manufacturing and/or measurement tolerances. Unless otherwise indicated, drawings should be understood as schematic and not to scale.

It should also be understood that, except where logic dictates otherwise, features shown or described with reference to one figure or example or embodiment can be combined with other features shown or described with reference to a different figure or example or embodiment. All processes described herein are also illustrative and can be modified. Operations can be performed in a different order from that described, to the extent that logic permits; operations described above may be omitted or combined; and operations not expressly described above may be added. In regard to any collection or exchange of information or data by or between devices, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Accordingly, although the invention has been described with respect to specific embodiments, it will be appreciated that the invention is intended to cover all modifications and equivalents within the scope of the following claims.

What is claimed is:

1. An electronic device comprising:
a housing having an interface surface; and
an annular magnetic alignment component disposed within the housing and having an axis normal to the interface surface, the annular magnetic alignment component having an inner annular region with a magnetic orientation in a first radial direction and an outer annular region with a magnetic orientation in second radial direction opposite the first radial direction.

2. The electronic device of claim 1 wherein the inner annular region and the outer annular region have equal radial widths.

3. The electronic device of claim 1 wherein the inner annular region and the outer annular region are separated by a non-magnetized region.

4. The electronic device of claim 3 wherein the inner annular region and the outer annular region have equal radial widths and the non-magnetized region has a narrower radial width.

5. The electronic device of claim 1 wherein the first radial direction is a radially inward direction and the second radial direction is a radially outward direction.

6. The electronic device of claim 1 wherein the annular magnetic alignment component comprises:
a plurality of first arcuate magnets arranged in an inner ring and polarized with the magnetic orientation in a radially inward direction; and
a plurality of second arcuate magnets arranged in an outer ring and polarized with the magnetic orientation in a radially inward direction.

7. The electronic device of claim 6 wherein the first arcuate magnets and the second arcuate magnets have equal radial widths.

8. The electronic device of claim 1 further comprising:
a rotational magnetic alignment component disposed within the housing outboard of and spaced apart from the annular magnetic alignment component.

9. The electronic device of claim 8 wherein the rotational magnetic alignment component includes a first magnetized region having a magnetic orientation in a first lateral direction, a second magnetized region having a magnetic orientation in a second lateral direction opposite the first lateral direction, and a first non-magnetized region between the first magnetized region and the second magnetized region.

10. The electronic device of claim 9 wherein the rotational magnetic alignment component further includes a third magnetized region having a magnetic orientation in the second lateral direction, a fourth magnetized region having a magnetic orientation in the first lateral direction, a second non-magnetized region between the first magnetized region and the third magnetized region, and a third non-magnetized region between the second magnetized region and the fourth magnetized region.

11. The electronic device of claim 1 further comprising:
an inductive coil disposed inboard of and coaxially with the annular magnetic alignment component, the inductive coil being configured to transfer power wirelessly through the interface surface.

12. The electronic device of claim 11 wherein the inductive coil is configured to receive power and use the received power to charge a battery of the electronic device.

13. An electronic device, comprising:
a housing having an interface surface;
an annular magnetic alignment component disposed within the housing and having an axis normal to the interface surface, the annular magnetic alignment component comprising:
an inner magnetized annular region having a magnetic polarity oriented in a first axial direction;
a middle magnetized annular region having a magnetic polarity oriented in a second axial direction opposite the first axial direction;
an outer magnetized annular region having a magnetic polarity oriented in the first axial direction;
a first non-magnetized annular region disposed between the inner magnetized annular region and the middle magnetized annular region; and
a second non-magnetized annular region disposed between the inner magnetized annular region and the middle magnetized annular region.

14. The electronic device of claim 13 further comprising:
an inductive coil disposed inboard of and coaxially with the annular magnetic alignment component, the inductive coil being configured to transfer power wirelessly through the interface surface.

15. The electronic device of claim 14 wherein the inductive coil is configured to transmit power to another electronic device.

16. The electronic device of claim 13 wherein the inner magnetized annular region, the middle magnetized annular region, and the outer magnetized annular region have equal radial widths.

17. The electronic device of claim 16 wherein the first non-magnetized annular region and the second non-magnetized annular region have equal radial widths.

18. The electronic device of claim 13 wherein the inner magnetized annular region has a first radial width, the middle magnetized annular region has a second radial width equal to the first radial width, and the outer magnetized annular region has a third radial width less than the first radial width.

19. The electronic device of claim 13 wherein the annular magnetic alignment component comprises a plurality of arcuate magnets, each arcuate magnet having:
a first arcuate magnetized region with a magnetic polarity oriented in the first axial direction;
a second arcuate magnetized region with a magnetic polarity oriented in the second axial direction;
a third arcuate magnetized region with a magnetic polarity oriented in the first axial direction;
a first arcuate non-magnetized region between the first and second arcuate magnetized regions; and
a second arcuate non-magnetized region between the second and third arcuate magnetized regions.

20. The electronic device of claim 13 further comprising:
a rotational magnetic alignment component disposed within the housing outboard of and spaced apart from the annular magnetic alignment component.
